(19) United States
(12) Patent Application Publication
(10) Pub. No.: US 2002/0146643 A1
(43) Pub. Date: Oct. 10, 2002

(54) Optical recording medium

(75) Inventors: Hiroshi Shingai, Tokyo (JP); Hajime Utsunomiya, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: TDK CORPORATION, Tokyo (JP)

(21) Appl. No.: 09/998,209

(22) Filed: Dec. 3, 2001

(30) Foreign Application Priority Data
Dec. 4, 2000 (JP) 2000-369219

(51) Int. Cl. G11B 7/24

(52) U.S. Cl. 430/270.13; 430/945; 369/275.2; 428/64.5

(57) ABSTRACT

The optical recording medium of the present invention has a phase change recording layer. This recording layer contains at least two elements selected from Sb, Te, Ge, and In as main elements, and at least one element selected from rare earth elements (Y, Sc, and lanthanoid), Zr, Hf, Ti and Sn as an auxiliary element, and also, a eutectic mixture can exist in the recording layer. The optical recording medium of the present invention can be operated at a high transfer rate, and has a high storage reliability.

### BACKGROUND OF THE INVENTION

1. Technical Field

This invention relates to a phase change optical recording medium.

2. Background Technology

There has been demands for an optical recording medium wherein recording of the information at a high recording capacity per unit area has been realized, namely, wherein a high density recording has been enabled, and wherein erasure and overwriting of the recorded information has also been enabled. One such medium that has been brought in use is the phase change recording medium wherein crystallographic state of the recording layer is changed by irradiating the medium with a laser beam during the recording, and wherein the reading is accomplished by detecting the difference in reflectivity between the recorded area and the unrecorded area.

In the recording of information on such phase change optical recording medium, the recording layer is irradiated with a laser beam of high power (recording power) so that the recording layer is heated to a temperature equal to or higher than the melting point. After the melting of the recording layer, the recording layer will be quenched to form an amorphous recorded mark. In the erasure of the recorded mark, the recording layer is irradiated with a laser beam of the power sufficient for heating the recording layer to a temperature equal to or higher than the crystallization temperature (erasing power level). After the heating, the recorded mark will be allowed to slowly cool to recover the crystalline state. Accordingly, in the phase change optical recording media, the medium can be overwritten by modulating the irradiation intensity of a laser beam (single light beam).

The phase change optical recording mediums of highest capacity that have been in use are DVD-RAM and DVD-RW having a recording capacity of 4.7 GB per one side, and the DVD-RAM has a transfer rate of 22 Mbps. However, further increase in the recording capacity and transfer rate are highly awaited in consideration of recording of digital broadcasting at home and recording of moving image in broadcasting business.

Various attempts have been made to realize increase in the density of the information to be recorded per unit area (higher recording density) and increase in the transfer rate of the information per unit rate (higher transfer rate) by reducing the recording/reading wavelength, by increasing numerical aperture of the objective lens used in the recording/reading optical system, and by increasing the linear velocity of the optical recording medium. These attempts, however, are associated with further decrease in the time of the laser beam irradiation of the recording layer, and hence, with difficulty in optimizing the overwriting conditions.

Increase in the recording linear velocity is associated with the decrease the time of the laser beam irradiation to the recording layer. In such a case, it is commonplace to prevent the decrease of the temperature to which the recording layer reaches by increasing the power used in the recording. However, when the recording linear velocity is further increased with further increase in the recording power, the time allowed for the quenching of the recorded area that has been irradiated with the laser beam will be further reduced, and it would be necessary to pay extra attention for the structural and thermal design of the optical recording medium including the recording layer.

The methods for increasing the transfer rate by increasing the recording linear velocity are disclosed, for example, in JP-A 1-78444, JP-A 10-326436, JP-A 2000-43415, JP-A 2000-52657, and JP-A 2-112987.

A recording layer with high crystallization speed, however, suffers from insufficient storage stability due to the low thermal stability and high susceptibility to crystallization of the recorded mark in amorphous state under relatively high-temperature conditions. In particular, storage stability is insufficient in the application where the recording layer is used at a high recording linear velocity of 10 m/s or more (70 Mbps or more in terms of the information transfer rate).

An object of the present invention is to provide a phase change optical recording medium which simultaneously has an improved transfer rate and a good storage stability which are in trade-off relationship with each other.

### SUMMARY OF THE INVENTION

Such an object is attained by the present invention as described below in (1) and (2).

(1) An optical recording medium having a phase change recording layer, wherein

the recording layer contains at least two elements selected from Sb, Te, Ge, and In as main elements, and at least one element selected from rare earth elements (Y, Sc, and lanthanoid), Zr, Hf, Ti and Sn as an auxiliary element; and

a eutectic mixture can exist in the recording layer.

(2) An optical recording medium having a phase change recording layer, wherein

the recording layer contains Sb and Te as main elements, and at least one element which has an atomic radius of at least 140 pm as an auxiliary element; and

Sb₇₀Te₃₀ can exist in the recording layer as a eutectic mixture.

### MECHANISM AND MERITS

The phase change recording layer in the optical recording medium of the present invention is the one which contains at least two elements selected from Sb, Te, Ge, and In as its main elements, and which can contain a eutectic mixture. In the present invention, the condition that the recording layer can contain a eutectic mixture means that a eutectic mixture can exist in the crystalline area of the recording layer.

In the present invention at least one element selected from rare earth elements (Y, Sc, and lanthanoid), Zr, Hf, Ti and Sn is further added as an auxiliary element to the recording layer of the composition where a eutectic mixture can exist. This enables improvement in the crystallization speed with no adverse effects on the thermal stability of the amorphous record mark. A phase change medium having excellent storage stability as well as high transfer rate is thereby provided.

### BRIEF DESCRIPTION OF THE DRAWINGS

FIG. 1 is a cross sectional view of the optical recording medium according to an embodiment of the present invention.

FIG. 2 is a cross sectional view of the optical recording medium according to another embodiment of the present invention.

### DESCRIPTION OF PREFERRED EMBODIMENTS

The phase change recording layer in the optical recording medium of the present invention is the one which contains at least two elements selected from Sb, Te, Ge, and In as main elements, and at least one element selected from rare earth elements (Y, Sc, and lanthanoid), Zr, Hf, Ti and Sn as an auxiliary element. This recording layer also has a composition wherein a eutectic mixture can exist in the layer.

Exemplary eutectic mixtures containing the at least two elements selected from Sb, Te, Ge, and In include Sb₇₀Te₃₀, Sb₁₀Te₉₀, Ge₁₅Te₈₅, and In₃₀Sb₇₀, whose composition is represented by atomic ratio.

In the present invention, the composition of the recording layer does not necessary match with that of the eutectic mixture as long as the composition of the recording layer admits the presence of the eutectic mixture. For example, the recording layer containing Sb₇₀Te₃₀ as the eutectic mixture may have a total composition (atomic ratio) of

{(SbₓTe₁₋ₓ)_{1-y}M_{y}}_{1-z}R_{z} (formula I)

wherein R represents the auxiliary element; M represents an element other than Sb, Te, and R; and x is preferably

0.45≦x≦0.95, and more preferably 0.6≦x≦0.9.

Improvement in the storage reliability which is a merit of the present invention is not sufficiently realized when x is either too small or too large. When x is too small, the effect of improving the crystallization speed by the addition of the auxiliary element will not be sufficient, whereas an excessively large x will result in the reduced difference between the crystalline and amorphous phases, and hence, in the reduced output signal.

The auxiliary element R is most preferably a rare earth metal. “z” which represents the content of the element R in the formula I is preferably

0.010≦z≦0.15, and more preferably 0.010≦z≦0.10.

However, when Zr and/or Hf is the only element included as R, z is preferably

0.035≦z≦0.15, and more preferably 0.035≦z≦0.10.

When z is too small, the merit of the present invention that improvements in the thermal stability and the crystallization speed of the recording layer are simultaneously realized will be insufficient. When z is too large, difference in reflectivity between the crystalline state and the amorphous state will be reduced to invite an inconvenient decrease in the output signal, and an excessively large z also results in the increase of the crystallization temperature, and hence, in the difficulty of the initialization.

The element M is an optional element added for realizing various effects. M is not limited to any particular element, and M may be at least one element selected from In, Ag, Au, Bi, Se, Al, P, Ge, H, Si, C, V, W, Ta, Zn, Pb, and Pd, and more preferably, at least one element selected from Ag, In, and Ge in view of the strong effects in improving the storage reliability. “y” which represents the content of the element M in the formula I is preferably

0≦y≦0.20, and more preferably 0≦y≦0.10.

An excessively high y may invite decrease in the output in the reading as well as decrease in the crystallization speed.

The element R should always have an atomic radius of at least 140 pm (picometer). It has been found that, however, when the recording layer has a composition which admits presence of Sb₇₀Te₃₀ as a eutectic mixture, increase in the crystallization temperature of the recording layer and increase in the crystallization speed of the recording layer can be simultaneously realized by adding an element which has an atomic radius of 140 pm or more as the auxiliary element even if the element added was an element other than those mentioned in the foregoing for the element R. When the total composition (atomic ratio) of the recording layer is represented by

{(SbₓTe₁₋ₓ)_{1-y}M_{y}}_{1-z}R¹⁴⁰_{z} (formula II)

wherein R¹⁴ represents the element having an atomic radius of 140 pm or more (with the proviso that R¹⁴⁰ is neither Sb nor Te), the definition of the element M, preferable elements for the element M, preferable range of the atomic ratio between x, y and z are the same as those for the formula I, respectively. It is to be noted that R¹⁴⁰ is most preferably the one selected from those mentioned for the element R.

In the recording layer containing Sb and Te as its main elements, Sb crystal or the crystal of Sb with other elements in the form of solid solution may be either rhombohedral or face centered cubic lattice. In the case of the recording layer which can include Sb₇₀Te₃₀ as the eutectic mixture, crystallization may become insufficient due to the addition of the auxiliary component as described above and the crystal structure may then become fine. The average grain size in the crystalline area in such case is preferably up to 20 nm, and more preferably about 5 to 10 nm.

Application of the present invention to the recording layer containing Sb and Te as its main elements as described above enables overwriting at a high recording linear velocity range with the recording linear velocity of 10 m/s or more and the information transfer rate of 70 Mbps or more with the thermal stability of the recording layer maintained at a sufficient level.

The optical recording medium of the present invention is not limited to any particular type as long as the auxiliary element as described above is included in the recording layer and a eutectic mixture can exist in the layer, and the medium may have any structure as long as the conditions as described above are fulfilled. Embodiments of the optical recording medium of the constitution to which the present invention is highly applicable are described below.

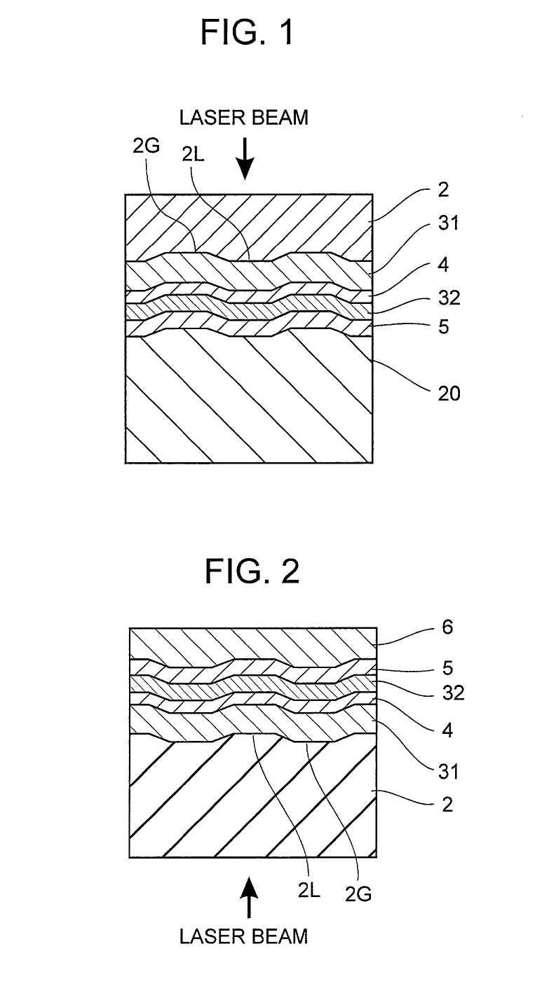

Structure Shown in FIG. 1

This optical recording medium comprises a supporting substrate 20, and a reflective layer 5 comprising a metal or a semimetal, a second dielectric layer 32, a recording layer 4, a first dielectric layer 31, and a light-transparent substrate 2 deposited on the supporting substrate 20 in this order. The laser beam for recording or reading enters the medium through the light-transparent substrate 2. It should be noted that an intermediate layer comprising a dielectric material may be optionally provided between the supporting substrate 20 and the reflective layer 5.

Supporting Substrate 20

The supporting substrate 20 is provided for the purpose of maintaining the rigidity of the medium, and the supporting substrate 20 may be formed from a resin or the like to a thickness of 0.2 to 1.2 mm, and preferably, to a thickness of 0.4 to 1.2 mm. The supporting substrate 20 may be either transparent or non-transparent. The grooves 2G generally provided in the recordable optical recording medium may be formed on the supporting substrate 20, and various layers may be formed on the grooved supporting substrate.

Reflective Layer 5

The reflective layer may be formed from any desired material, and typically, from a metal or a semimetal such as Al, Au, Ag, Pt, Cu, Ni, Cr, Ti or Si as a simple substance or as an alloy containing at least one of such metals. The reflective layer may be formed by sputtering or the like.

The reflective layer is preferably formed to a thickness of 10 to 300 nm.

First Dielectric Layer 31 and Second Dielectric Layer 32

These dielectric layers prevent oxidation and degradation of the recording layer. These dielectric layers also have the effects of blocking the heat transmitted from the recording layer during the recording or dissipating such heat in in-plane direction of the layer. The dielectric layer may comprise either a single layer or a laminate of two or more layers each having different compositions.

The dielectric material used for these dielectric layers is preferably a compound which is an oxide, a nitride, or a sulfide containing at least one metal component selected from Si, Ge, Zn, Al, and rare earth elements. A mixture containing two or more of the foregoing may also be used.

The thickness of the first and the second dielectric layers may be adequately determined so that sufficient improvement in the protection and degree of modulation are achieved. However, the first dielectric layer 31 is preferably deposited to a thickness of 30 to 300 nm, and more preferably to a thickness of 50 to 250 nm, and the second dielectric layer 32 is preferably deposited to a thickness of 3 to 50 nm. It is to be noted that when the overwriting is accomplished at a high linear velocity as in the case of the present invention, the second dielectric layer is preferably formed to a thickness of 3 to 30 nm, and more preferably, to a thickness of 3 to 25 nm.

The dielectric layers are preferably formed by sputtering.

Recording Layer 4

The recording layer may be formed so that the resulting recording layer has the constitution as described above.

The recording layer is preferably formed to a thickness of 4 nm to 50 nm, and more preferably, to a thickness of 5 nm to 30 nm. When the recording layer is too thin, growth of the crystalline phase will be difficult to render the crystallization difficult. When the recording layer is too thick, the recording layer will have an increased heat capacity and irradiation of sufficient laser beam will be difficult. An excessively thick recording layer also results in the reduced output signal.

The recording layer is preferably formed by sputtering.

It is to be noted that the recording layer of the present invention does not necessarily comprise a single layer, and the present invention is applicable to a medium having a recording layer of multilayer structure, for example, those described in JP-A 8-221814 and JP-A 10-226173.

Light-transparent Substrate 2

The light-transparent substrate 2 should have the transparency sufficient for recording/reading laser beam to pass therethrough, and the light-transparent substrate 2 may comprise a resin plate or a glass plate of the thickness substantially equivalent to that of the supporting substrate 20. However, when the high recording density is to be achieved by increasing the NA of the recording/reading optical system, the thickness of the light-transparent substrate 2 is preferably reduced to the range of 30 to 300 μm. When the light-transparent substrate is too thin, the medium will suffer from the optical effects caused by the dust on the surface of the light-transparent substrate. An excessively thick light-transparent substrate, on the other hand, will result in the difficulty of enabling the high density recording by increasing the NA.

The light-transparent substrate 2 of reduced thickness may be provided, for example, by adhering a light-transparent sheet comprising a light-transparent resin on the first dielectric layer 31 by means of an adhesive or pressure-sensitive adhesive, or by directly forming the light-transparent resin layer on the first dielectric layer 31 by coating.

Structure Shown in FIG. 2

FIG. 2 shows an embodiment of the optical recording medium which comprises a light-transparent substrate 2, and a first dielectric layer 31, a recording layer 4, a second dielectric layer 32, a reflective layer 5, and a protective layer 6 deposited on the light-transparent substrate 2 in this order. The laser beam enters the medium through the light-transparent substrate 2.

The light-transparent substrate 2 of FIG. 2 may comprise a layer similar to the supporting substrate 20 of FIG. 1. The light-transparent substrate 2, however, should be capable of transmitting the light.

The protective layer 6 is provided for improving scratch resistance and corrosion resistance. Preferably, the protective layer is formed of an organic material, and typically, a radiation curable compound or a composition thereof which has been cured with radiation such as electron or UV radiation. The protective layer may generally have a thickness of about 0.1 to about 100 μm, and may be formed by conventional techniques such as spin coating, gravure coating, spray coating, and dipping.

Other layers are similar to the embodiment shown in FIG. 1.

### EXAMPLES

### Example 1

A sample of an optical recording medium having the structure of FIG. 1 which is recorded by land/groove recording system was produced by the procedure as described below.

A disk-shaped supporting substrates having a diameter 120 mm, and a thickness 1.2 mm was produced from polycarbonate by injection molding with a ridge/valley pattern on a surface corresponding to the grooves and lands.

Next, a reflective layer comprising Ag as its main component was formed by sputtering to a thickness of 100 nm.

On the reflective layer was formed an Al₂O₃ layer of 20 nm thick by sputtering as a second dielectric layer 32.

Next, a recording layer 4 was formed by sputtering in argon atmosphere by using an alloy target. The recording layer had the composition in atomic ratio of:

{(Sb_{0.82}Te_{0.18})_{0.93}(In_{0.14}Ge_{0.86})_{0.07}}_{1-z}R_{z}

wherein z represents the content of element R which is the auxiliary element of the present invention or element W added for comparison purpose, and the recording layer was formed so that z was at the value shown in Tables 1 and 2. The recording layer had a thickness of 12 nm.

The first dielectric layer 31 was formed by sputtering to a dual layer structure comprising the lower dielectric layerole of ZnS (50 mole %)—SiO₂ (50 mole %) on the side of the recording layer 4 and the upper dielectric layer of ZnS (80 mole %)—SiO₂ (20 mole %). The lower and the upper dielectric layers were formed to a thickness of 5 nm and 130 nm, respectively.

The light-transparent substrate 2 was formed by spin coating a UV-curable resin and curing the coating by UV irradiation. The light-transparent substrate 2 was formed to a thickness of 0.1 mm.

Also produced were comparative samples having the recording layer comprising the main component of Sb₂Te₃ with an auxiliary element added thereto, and the recording layer comprising the main component of Ge₂Sb₂Te₅ with an auxiliary element added thereto. These comparative samples were the same as the samples of the present invention except for the composition of the recording layer. These comparative samples contained the auxiliary element R at the content shown in Tables 3 and 4.

The samples produced as described above were initialized (crystallized) on a bulk eraser, and the samples were then recorded under the conditions:

wavelength λ: 405 nm,

numerical aperture, NA: 0.85, and

recording signal: 8T single signal (1-7 modulation).

The linear velocity used in the recording and the corresponding information transfer rate are shown in the Table. Next, the track recorded with the signal was erased by irradiating the track with a direct current laser beam at a linear velocity the same as the one used in the recording. The output of the direct current laser beam was adjusted so that the erasability at each linear velocity was at its maximum. CNR (carrier to noise ratio) was measured before and after the erasing operation to determine attenuation of the 8T signal carrier (erasability). The results are shown in the Tables, below.

TABLE 1
Composition of the recording layer: {(Sb_{0.82}Te_{0.18})_{0.93}(In_{0.14}Ge_{0.86})_{0.07}}_{1-z}R_{z}

| | | Content | Erasability (dB) | | | | | |
|---|---|---|---|---|---|---|---|---|
| Sample | Element | of R | V = 6.5 m/s | V = 11.4 m/s | V = 16.3 ms | V = 22.8 m/s | V = 26.0 m/s | V = 28.0 m/s |
| No. | R | z | (40 Mbps) | (70 Mbps) | (100 Mbps) | (140 Mbps) | (160 Mbps) | (170 Mbps) |
| 101 | — | — | — | 29.3 | 12.5* | 4.2* | — | — |
| (Comp.) | | | | | | | | |
| 102 | Ti | 0.020 | — | 26.5 | 28.5 | 23.2* | — | — |
| 103 | Ti | 0.040 | — | 26.1 | 27.1 | 28.5 | — | — |
| 104 | Sn | 0.038 | — | 34.2 | 24.2* | 8.5* | — | — |
| 105 | Sn | 0.082 | — | 35.8 | 33.0 | 24.6* | — | — |
| 106 | Hf | 0.023 | — | 33.2 | 24.6* | 10.7* | — | — |
| 107 | Hf | 0.059 | — | 28.2 | 27.6 | 26.6 | — | — |
| 108 | | Y | 0.040 | — | — | 32.8 28.2 | 20.1* | — |

*Unerasable
Comp.: Comparative

TABLE 2
Composition of the recording layer: {(Sb_{0.82}Te_{0.18})_{0.93}(In_{0.14}Ge_{0.86})_{0.07}}_{1-z}R_{z}

| | | Content | Erasability (dB) | | | | | |
|---|---|---|---|---|---|---|---|---|
| Sample | Element | of R | V = 6.5 m/s | V = 11.4 m/s | V = 16.3 ms | V = 22.8 m/s | V = 26.0 m/s | V = 28.0 m/s |
| No. | R | z | (40 Mbps) | (70 Mbps) | (100 Mbps) | (140 Mbps) | (160 Mbps) | (170 Mbps) |
| 201 | Zr | 0.039 | — | 37.7 | 34.9 | 18.4* | — | — |
| 202 | Dy | 0.041 | — | — | 30.1 | 30.9 | — | 24.3* |
| 203 | Gd | 0.040 | — | — | 35.0 | 27.6 | — | — |
| 204 | Tb | 0.024 | — | 30.6 | 28.1 | — | — | — |
| 205 | Tb | 0.040 | — | — | 36.5 | 28.0 | — | — |
| 206 | W** | 0.022 | — | 29.2 | 18.7* | — | — | — |
| (Comp.) | | | | | | | | |
| 207 | W** | 0.044 | — | 11.7* | — | — | — | — |
| (Comp.) | | | | | | | | |

*Unerasable
**Outside the defined range

TABLE 3
Composition of the recording layer: Sb₂Te₃ + R

| | | Content | Erasability (dB) | | |
|---|---|---|---|---|---|
| Sample | Element | of R | | V = 3.5 | |
| No. | R | (atom %) | V = 1.5 m/s | m/s | V = 6.5 m/s |
| 301(Comp.) | — | — | 4.3* | 3.9* | 0.5* |
| 302(Comp.) | Tb | 4.0 | 4.9* | 1.5* | 0.5* |
| 303(Comp.) | Tb | 8.0 | 0.5* | 0* | 0* |

*Unerasable

TABLE 4
Composition of the recording layer: Ge₂Sb₂Te₅ + R

| | | Content | | | |
|---|---|---|---|---|---|
| Sample | Element | of R | Erasability (dB) | | |
| No. | R | (atom %) | V = 1.5 m/s | V = 3.5 m/s | V = 6.5 m/s |
| 401 | — | — | — | 15.3* | — |
| (Comp.) | | | | | |
| 402 | Tb | 4.0 | — | 5.3* | — |
| (Comp.) | | | | | |

*Unerasable

The results in the tables demonstrates the merits of the present invention. To be more specific, addition of the auxiliary element of the present invention to the

(Sb_{0.82}Te_{0.18})_{0.93}(In_{0.14}Ge_{0.86})_{0.07} which is close to the eutectic mixture of Sb₇₀Te₃₀ resulted in significant improvement in the erasability at higher linear velocities. In contrast, when the auxiliary element of the present invention was added to intermetallic compounds Sb₂Te₃ and Ge₂Sb₂Te₅, addition of the auxiliary element resulted in the decrease of the erasability.

### Example 2

Of the samples made in Example 1, the sample of the present invention containing 4 atom % of Tb, namely, the sample having the recording layer composition:

{(Sb_{0.82}Te_{0.18})_{0.93}(In_{0.14}Ge_{0.86})_{0.07}}_{0.96}Tb_{0.04} was stored under high temperature, high humidity environment of 80° C. and 80% RH to evaluate decrease in the CNR associated with the storage. Similar evaluation for comparison purpose was also conducted for the comparative sample prepared by adding Sb instead of Tb. The recording layer of this comparative sample had the composition:

{(Sb_{0.82}Te_{0.18})_{0.93}(In_{0.14}Ge_{0.86})_{0.07}}_{0.68}Sb_{0.32}.

The amount of Sb added in this comparative sample was determined so that the maximum recording linear velocity at which the erasability of 25 dB or higher is achieved would be substantially the same as the sample having Tb added thereto.

The CNR of the 8T signal at the recording linear velocity of 22.8 m/s in the case of the comparative sample was initially 52.8 dB and 24.9 dB after 50 hours of storage to indicate marked decrease in the CNR by the storage. In contrast, in the sample of the present invention, the CNR was initially 54.3 dB and 54.2 dB after 200 hours of storage to confirm the marked improvement in the thermal stability enabled by the Tb addition. It is to be noted that the samples of the present invention prepared by adding an auxiliary element other than Tb also showed remarkable improvement in the thermal stability.

1. An optical recording medium having a phase change recording layer, wherein
the recording layer contains at least two elements selected from Sb, Te, Ge, and In as main elements, and at least one element selected from rare earth elements (Y, Sc, and lanthanoid), Zr, Hf, Ti and Sn as an auxiliary element; and
a eutectic mixture can exist in the recording layer.

2. An optical recording medium having a phase change recording layer, wherein
the recording layer contains Sb and Te as main elements, and at least one element which has an atomic radius of at least 140 pm as an auxiliary element; and
wherein the recording layer can include Sb₇₀Te₃₀ as a eutectic mixture.
